(19) United States
(12) Patent Application Publication
(10) Pub. No.: US 2023/0169437 A1
(43) Pub. Date: Jun. 1, 2023

(54) SERVERS, SYSTEMS, AND METHODS FOR FAST DETERMINATION OF OPTIMAL SETPOINT VALUES

(71) Applicant: AVEVA SOFTWARE, LLC, Lake Forest, CA (US)

(72) Inventors: Shantanu Chakraborty, Sydney (AU); Zhen Zhao, Sydney (AU); Simon Alabaster, Sydney (AU)

(21) Appl. No.: 18/071,212

(22) Filed: Nov. 29, 2022

Related U.S. Application Data
(60) Provisional application No. 63/284,249, filed on Nov. 30, 2021.

(51) Int. Cl. G06Q 10/06

(52) U.S. Cl. CPC G06Q 10/06393

(57) ABSTRACT

This disclosure is directed to a system for determining optimum setpoints for equipment in an industrial process. In some embodiments, the system does not use first-principles models to determine ideal setpoints. Instead, the system uses actual historical data and determines the setpoints at which the highest and/or longest key performance indexes were achieved according to some embodiments. In some embodiments, the system is able to save computer resources by reducing processing power through the use of a survival matrix as opposed to an iterative model. In some embodiments, the survival matrix is derived from statistical calculations on the historical data for KPI achieved timeframes.

### CROSS-REFERENCE TO RELATED APPLICATION

This application claims the benefit of and priority to U.S. Provisional Application No. 63/284,249, filed Nov. 30, 2021, which is incorporated herein by reference in its entirety.

### BACKGROUND

Current process simulation modeling involves the use of equations to model the characteristics and/or effects of a manufacturing facility component process. Examples of these equations for simple processes may be PV=nRT to model an ideal gas, or V=IR to model electrical parameters. Other processes may involve multiple complex equations to accurately model the components. Some of these equations may be non-linear which adds another layer of difficulty. Current modeling methods only yield approximate values as true data is not considered. Because these approximations are theoretical values, they are not useful for determining optimum setpoints for fully operational manufacturing components. When operational, industrial and manufacturing components can be exposed to additional unknown variables such as external environmental factors that can result in deviations from a theoretical model. External variables, such as temperature fluctuating over time, for example, causes variation in a process not accounted for in the equation modeled system. For these reasons, theoretical models are less useful for optimizing setpoints for running processes.

Therefore, there is a need for systems and methods capable of optimizing operational industrial and/or manufacturing components and processes using real-time and/or near-real time and/or historical data.

### SUMMARY

Systems and methods described herein (referred to throughout this disclosure as the “system”) are directed to optimizing setpoints for operational industrial processes. As used herein, industrial processes include manufacturing facilities, research facilities, and/or any facility where KPIs are used to measure performance. In some embodiments, the system is configured to provide efficient KPI-objective evaluation due to the implementation of a novel pseudo-process model, where the pseudo-process model includes a survival matrix according to some embodiments. By using existing data to model the actual effects a combination of setpoints in a process has on a product instead of first-principles equations, valuable computer resources are saved according to some embodiments.

In some embodiments, the system is configured to derive optimized set-points for various Key Performance Indices (or Indicators) (KPIs) through pseudo-process model generation and optimization of setpoints utilizing the pseudo-process models (also referred to herein as pseudo models). In some embodiments, the system is agnostic to the type of process and can therefore be implemented for any industry KPI. Non-limiting examples of KPIs may include throughput, defects, and yield according to some embodiments.

In some embodiments, the system includes one or more of a historian server database, an aggregation unit (AU) (unit and module, referring to portion of a program that comprises one or more routines, are synonymous in this disclosure), a pseudo-process modeling unit (PMU), a model storage database, and a setpoint optimizer unit (SOU). In some embodiments, the AU includes a statistical aggregation unit (SAU) and/or a dynamic aggregation unit (DAU). In some embodiments, the PMU includes a data validation unit (DVU) and/or a model generation unit (MGU).

In some embodiments, the AU is configured to generate a survival model based on the concept of reliability theory to approximate a process model resulting in a pseudo-process model. The term “process” as used herein may include a single component (e.g., piece of equipment) and/or a plurality of components. In some embodiments, the survival model includes a definition of process efficiency in the form of a survival function. In some embodiments, the survival model incorporates one or more related process features as covariates. In some embodiments, the process features include a setpoint, mean, and/or a standard deviation.

In some embodiments, the SAU is configured to receive, from the historian server database, historical operational data obtained from a process. The historical operational data may be data obtained from one or more sensors monitoring the process according to some embodiments. In some embodiments, the historical operational data includes one or more tags including one or more setpoints associated with the one or more tags. In some embodiments, the SAU is configured to down-sample the historical operational data to create statistical data. In some embodiments, the statistical data includes a mean and/or standard deviation for each setpoint. In some embodiments, the statistical data comprises one or more setpoints.

In some embodiments, the historical operational data includes one or more Key Performance Indicators (KPIs) such as yield or throughput as non-limiting examples. In some embodiments, the dynamic aggregation unit is configured to correlate each setpoint to a defined KPI. For example, in a process with 3 steps and three corresponding components, where setpoints vary according to product run at each step, the DAU is configured to correlate the KPI measured product with the setpoint at the time the product passed through each step. In some embodiments, the DAU is configured to generate a survival model (also referred to as a survival matrix). In some embodiments, the survival model is used to train an artificial intelligence (AI) driven pseudo model.

In some embodiments, the SAU is configured to send the survival model to the process modeling unit. In some embodiments, the process modeling unit includes a data validation unit. In some embodiments, the survival model is validated by the data validation unit using curve fitting data modeling techniques (e.g., regression models; conventional modeling techniques). In some embodiments, the validated model is sent to the model generation unit where it is used to train the (AI driven) pseudo model. Once the pseudo model is created, it is stored in the model storage database according to some embodiments.

In some embodiments, the setpoint optimizer unit (SOU) is configured to receive, from the model storage database, the pseudo model and associated model constraints. In some embodiments, the SOU is configured to determine one or more optimum process setpoints using the results of the pseudo model. In some embodiments, the SOU is configured to automatically adjust one or more process setpoints based on the results of the pseudo model (survival model/matrix). In some embodiments, as the historian server data receives the results of the setpoint optimization and resulting KPI, the process repeats and is further refined. In some embodiments, the system is configured to generate a single model per KPI of interest.

In some embodiments, the system does not include a first-principal equation model to determine an optimum system setpoint. By utilizing historical process data instead of first-principal models, the system saves valuable computer resources by generating optimized values for a process model without having to go through multiple iterations of first-principal equations according to some embodiments.

In some embodiments, the disclosure is directed to a system for execution of optimum setpoints. In some embodiments, the system comprises one or more computers comprising one or more processors and one or more non-transitory computer readable media, the one or more non-transitory computer readable media comprising program instructions stored thereon that when executed cause the one or more computers to execute one or more program steps. In some embodiments, a program step includes a command to generate, by the one or more processors, a graphical user interface (GUI) configured to enable a user to input one or more controllable variables that correspond to one or more equipment setpoints of at least one component in an industrial process. In some embodiments, a program step includes a command to receive, by the one or more processors, setpoint historical data including the one or more equipment setpoints during an operational timeframe. In some embodiments, a program step includes a command to receive, by the one or more processors, key performance indicator (KPI) historical data comprising one or more key performance indicators that each include a measure of the at least one component during the operational timeframe. In some embodiments, a program step includes a command to determine, by the one or more processors, one or more setpoint timeframes where the key performance indicators are above a predetermine value. In some embodiments, a program step includes a command to return, by the one or more processors, one or more setpoint values that include the one or more equipment setpoints during the one or more setpoint timeframes. In some embodiments, a program step includes a command to display, by the one or more processors, the one or more setpoint values on the GUI.

In some embodiments, the one or more non-transitory computer readable media further comprising program instructions stored thereon that when executed cause the one or more computers to generate, by the one or more processors, a pseudo process model. In some embodiments, a program step includes a command to include, by the one or more processors, one or more KPI achieved timeframes that include where one or more key performance indicators are above a predetermine value. In some embodiments, a program step includes a command to exclude, by the one or more processors, one or more non-KPI achieved timeframes where the one or more key performance indicators are below the predetermine value from the pseudo process model.

In some embodiments, a program step includes a command to execute, by the one or more processors, a setpoint calculation configured to determine one or more optimum setpoint values for the one or more components that correspond to the one or more equipment setpoints during the one or more KPI achieved timeframes. In some embodiments, a program step includes a command to display, by the one or more processors, the one or more optimum setpoint values on the GUI.

In some embodiments, the one or more non-transitory computer readable media further comprising program instructions stored thereon that when executed cause the one or more computers to execute, by the one or more processors, a command to change the one or more equipment setpoints of the at least one component in the industrial process to the one or more optimum setpoint values.

In some embodiments, the one or more non-transitory computer readable media further comprising program instructions stored thereon that when executed cause the one or more computers to generate, by the one or more processors, a graphical user interface (GUI) comprising an optimum setpoint limit input, the optimum setpoint limit input configured to enable a user to implement a setpoint value limit and a setpoint range limit for the one or more setpoint values. In some embodiments, a program step includes a command to execute, by the one or more processors, a down-sample command configured to reduce a number of time series data points in the setpoint historical data before generation of the pseudo model. In some embodiments, the one or more setpoint values includes a mean value and/or standard deviation value. In some embodiments, the system is configured to set an optimum setpoint range to the standard deviation value. In some embodiments, the optimum setpoint range is less than the setpoint range limit.

In some embodiments, the system includes structure for the execution of optimum setpoints that comprises a historian server, a statistical aggregation unit, a dynamic aggregation unit, and one or more computers comprising one or more processors and one or more non-transitory computer readable media, the one or more non-transitory computer readable media comprising program instructions stored thereon that when executed cause the one or more computers to execute one or more programs. In some embodiments, the one or more programs include a step to receive, by the statistical aggregation module, historical operational data from one or more sensors monitoring a process, the historical operational data including one or more tags and one or more setpoints associated with the one or more tags. In some embodiments, the one or more programs include a step to execute, by the statistical aggregation unit, a down-sample of the historical operational data to create statistical data, the statistical data including one or more of a mean and a standard deviation for each of the one or more setpoints. In some embodiments, the one or more programs include a step to execute, by the one or more processors, a setpoint calculation configured to determine one or more optimum setpoint values for the one or more components that correspond to the one or more setpoints during one or more key performance indictor (KPI) achieved timeframes. In some embodiments, the one or more programs include a step to display, by the one or more processors, the one or more optimum setpoint values on the GUI.

In some embodiments, the one or more non-transitory computer readable media further comprise program instructions stored thereon that when executed cause the one or more computers to correlate, by the dynamic aggregation unit, each setpoint to the one or more key performance indicators (KPIs). In some embodiments, the one or more programs include a step to determine, by the dynamic aggregation unit, one or more setpoint timeframes where the KPIs are above a predetermine value. In some embodiments, the one or more programs include a step to return, by the dynamic aggregation unit, one or more setpoint values that include the one or more setpoints during the one or more setpoint timeframes.

In some embodiments, the one or more non-transitory computer readable media further comprise program instructions stored thereon that when executed cause the one or more computers to generate, by the one or more processors, a survival model that includes an optimum value that includes an optimum highest value for each of the one or more setpoints that correlate to the highest KPI values and/or an optimum longest value for each of the one or more setpoints that correlate to a longest duration of meeting or exceeding a predetermined KPI value.

In some embodiments, the system further comprises, a data validation unit and/or a model generation unit. In some embodiments, the one or more programs include a step to send, by the statistical aggregation unit, the survival model to the data validation unit. In some embodiments, the one or more programs include a step to execute, by the data validation unit, a data validation of the survival model using curve fitting data modeling techniques.

In some embodiments, the system further includes a setpoint optimizer unit. In some embodiments, the one or more non-transitory computer readable media further comprise program instructions stored thereon that when executed cause the one or more computers to adjust, by the setpoint optimizer unit, one or more process setpoints based on the results of the survival model. In some embodiments, the system does not include a first-principals equation model to determine the optimum value. In some embodiments, the system does not include an iteration of a first-principals equation to determine the optimum value. In some embodiments, the system does not include an iteration model to determine the optimum value. In some embodiments, the survival model includes a mean and a standard deviation for each of the one or more setpoints. In some embodiments, the one or more programs include a step to generate, by the one or more processors, a graphical user interface, the graphical user interface including one or more bar charts, the one or more bar charts depicting a duration for each of the one or more optimum values.

### DRAWING DESCRIPTION

FIG. 1 illustrates a non-limiting example process of transforming timeseries data to a survival matrix with dynamic aggregation according to some embodiments.

FIG. 2 shows the graph of FIG. 1 transformed into a bar chart for visualization according to some embodiments.

FIG. 3 shows the resulting survival model (pseudo process model) as a black-box, S according to some embodiments.

FIG. 4 illustrates a system execution flow according to some embodiments.

FIG. 5 depicts an execution workflow for automatic setpoint optimization for a process and/or component according to some embodiments.

FIG. 6 illustrates a computer system enabling or comprising the systems and methods in accordance with some embodiments of the system.

### DETAILED DESCRIPTION

The following detailed description is a non-limiting example of a computer executing the systems and methods described herein according to some embodiments. It is understood that the system can take various forms and arrangements, and that the following disclosure of the system's implementation is only to aid those of ordinary skill in making and using the system by borrowing from some embodiments presented herein.

In some embodiments, the system includes one or more computers comprising one or more processors and one or more non-transitory computer readable media. In some embodiments, the non-transitory computer readable media includes instructions stored thereon that when executed cause the one or more computers to implement one or more steps.

In some embodiments, a step includes transforming, by the one or more processors, timeseries data to a survival matrix (or model). In some embodiments, the survival matrix is generated by using statistics (e.g., mean, standard deviation) to down sample raw time-series data for one or more setpoints. In some embodiments, the down sampled data is placed into a survival matrix. In some embodiments, the survival matrix includes dynamic aggregation. In some embodiments, dynamic aggregation includes data from controllable (i.e., variable) features such as setpoints.

In some embodiments, typical timeseries data includes time sampled features and targets. In some embodiments, features include equipment tags. In some embodiments, equipment tags include one or more of controllable tags (typically setpoints), observation tags, exogenous sensor values, and any conventional tags associated with equipment monitoring. In some embodiments, the tags used by the system are controllable tags. In some embodiments, the down sampled data is obtained by taking the mean and standard deviation of the historical operational data for a component operating at a setpoint. In some embodiments, the historical operational data includes actual recorded equipment values and/or setpoint values. In some embodiments, the setpoints including the mean and standard deviation are used by the system as predictor variables and/or covariates.

In some embodiments, a step includes training, by the one or more processors, a survival model (pseudo process model) using the survival matrix. In some embodiments, this allows the model to be generated with reasonable accuracy.

In some embodiments, a step includes optimizing, by the one or more processors, the survival model using Bayesian optimization. In some embodiments, using Bayesian optimization includes providing operating bounds of the setpoints. In some embodiments, using Bayesian optimization enables the system to determine the (pseudo) optimal setpoints for the operational components. As used herein, optimal, optimizing and similar terms are not limited to the fully optimal or optimized solutions, but also cover solutions which are suboptimal within a range of two percent of being fully optimized.

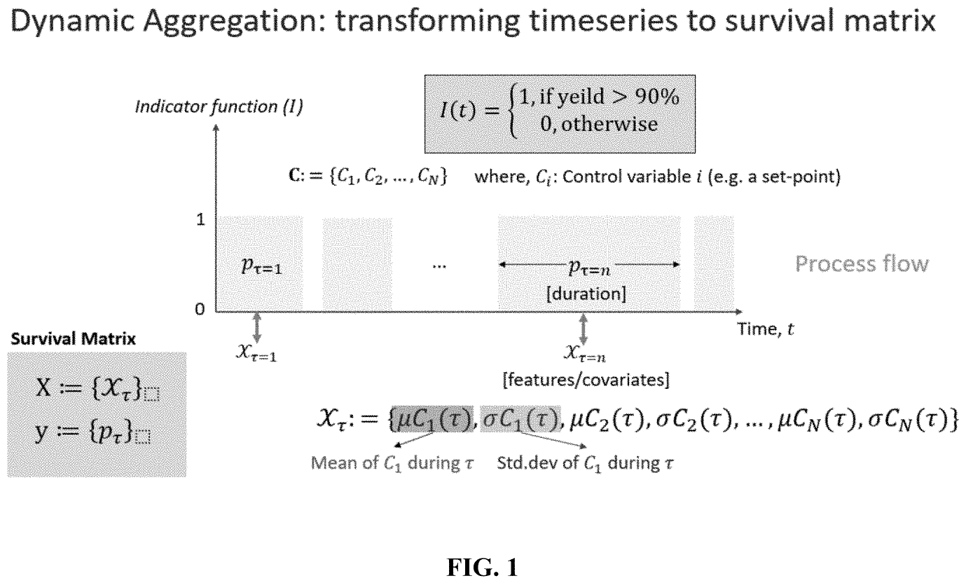

FIG. 1 illustrates a non-limiting example process of transforming timeseries data to a survival matrix with the dynamic aggregation unit/module according to some embodiments. For this example, on the timeseries graph the KPI (yield, in this non-limiting example) is mapped as an indicator function (I) in the y-axis which represents a yield of greater than 90%. In some embodiments, indicator function represents a pre-determined value above which the KPI is satisfied. In some embodiments, the x-axis represents time, where setpoint X_{τ} represents the amount of time the process is at the setpoint C (e.g., temperature), where the mean μ and standard deviation σ of C is included as covariates. Other C values may represent other setpoints (e.g., different temperatures) according to some embodiments. P_{τ} represents the duration where the setpoint X₉₆ achieves the desired KPI. In this example, each block P_{τ} on the graph represents the amount of time yield is greater than 90% for a given temperature setpoint, where blank spaces represent a temperature setpoint where the KPI was not achieved.

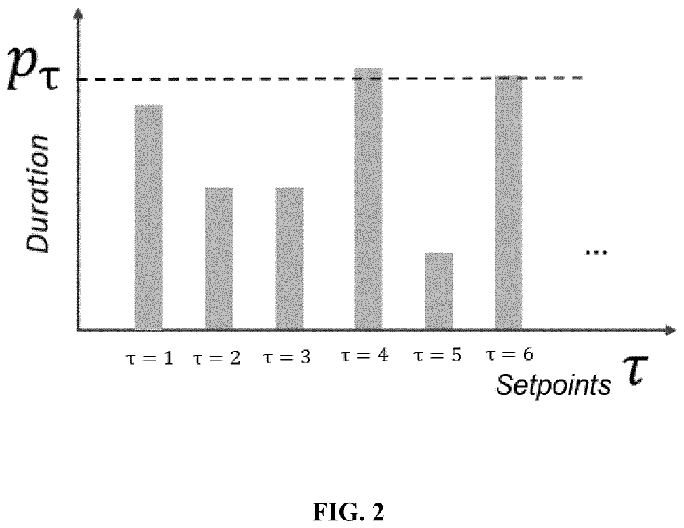

FIG. 2 shows the graph of FIG. 1 transformed into a bar chart for visualization according to some embodiments. Each bar τ=1-6 represents a setpoint where the KPI was achieved at some duration Pτ. However, temperature setpoint τ=4 resulted in the most product achieving a yield greater than 90%. Therefore, τ=4 is the optimum temperature setpoint for this equipment. Since the analysis includes both the mean and standard deviation, the system is configured to automatically control modification of one or more of an operational setpoint and operational control limits using this data according to some embodiments.

In some embodiments, this analysis is then used to train artificial intelligence (e.g., XGBoost based PH method; RNN-LSTM/GRU). In some embodiments, the system is configured to validate the model using by using a regression model such as Kaplan-Meir non-parametric method (Weibull distribution fitting, univariate) and/or Cox Proportional Hazard (PH) method (Least-square regression with covariates) as non-limiting examples. In some embodiments, XBoost is based on Cox Proportional Hazard Model. In some embodiments, the model results in a reasonable concordance index (form of accuracy).

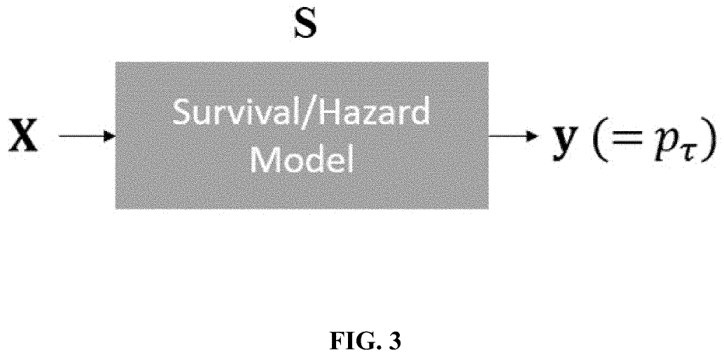

FIG. 3 shows the resulting survival model (pseudo process model) as a black-box, S according to some embodiments. In some embodiments, the system is configured to implement Bayesian Optimization to find X that maximized a KPI-driven objective function f(X) with the operational system's constraints. In some embodiments, the system is configured to set operation bounds of each setpoint.

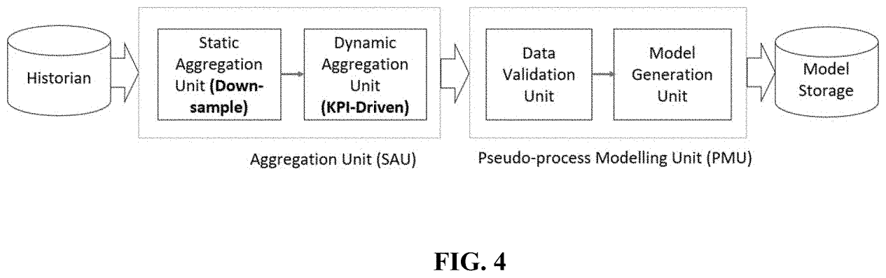

FIG. 4 illustrates a system execution flow according to some embodiments. In some embodiments, the system starts with raw time series data stored in a historian server database. In some embodiments, the aggregation unit (AU) is configured to download the operational historical data for a given process or component. In some embodiments, the aggregation unit comprises a statistical aggregation unit (SAU) configured to down-sample the historical operational data and/or determine the mean and standard deviation of the operational historical data for each setpoint. In some embodiments, the aggregation unit comprises a dynamic aggregation unit (DAU). In some embodiments, the statistical aggregation unit is configured to send the down-sampled historical operational data for each setpoint to the dynamic aggregation unit where the black box model S is generated as described above.

In some embodiments, the AU is configured to send the black box model to a pseudo-process modeling unit (PMU). In some embodiments, the PMU includes a data validation unit and a model generation unit. In some embodiments, the data validation unit validates the model by using the same historical operational data in a different model type as described above. In some embodiments, the data validation unit is configured to send the validated model to a model generation unit (MGU).

In some embodiments, the MGU is configured to create a final model which determines an optimum setpoint from the historical data. As used herein, the term optimum setpoint is a reference to both a proper name of a calculation and the result of the calculation, where the result includes a highest probability for achieving the KPI. In some embodiments, the optimum setpoint returned by the model may be one or more of a setpoint in the historical operational data and a setpoint not in the historical operational data but determined by the artificial intelligence as a configuration that would yield the highest KPI. For example, in some embodiments, the system is configured to estimate a non-linear temperature-KPI relationship from each of the setpoints below, and the AI uses this relationship to predict an optimum setpoint not previously within the historical data but within the process constraints.

In some embodiments, the model generation unit is configured to create a final model with a user interface to enable a user to enter one or more setpoints into the model to determine a resulting KPI. In some embodiments, the PMU is configured to send the final model to a module storage database.

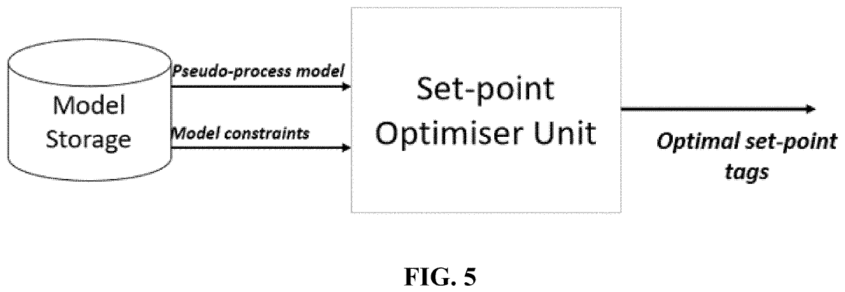

FIG. 5 depicts an execution workflow for automatic setpoint optimization for a process and/or component according to some embodiments. In some embodiments, the system comprises a set-point optimizer unit. In some embodiments, the set-point optimizer unit is configured to retrieve the pseudo-process model and the model constraints from the model storage database. In some embodiments, the set-point optimizer unit is configured to automatically implement the model determined setpoint from the final model stored in the model storage database for each respective component and/or process.

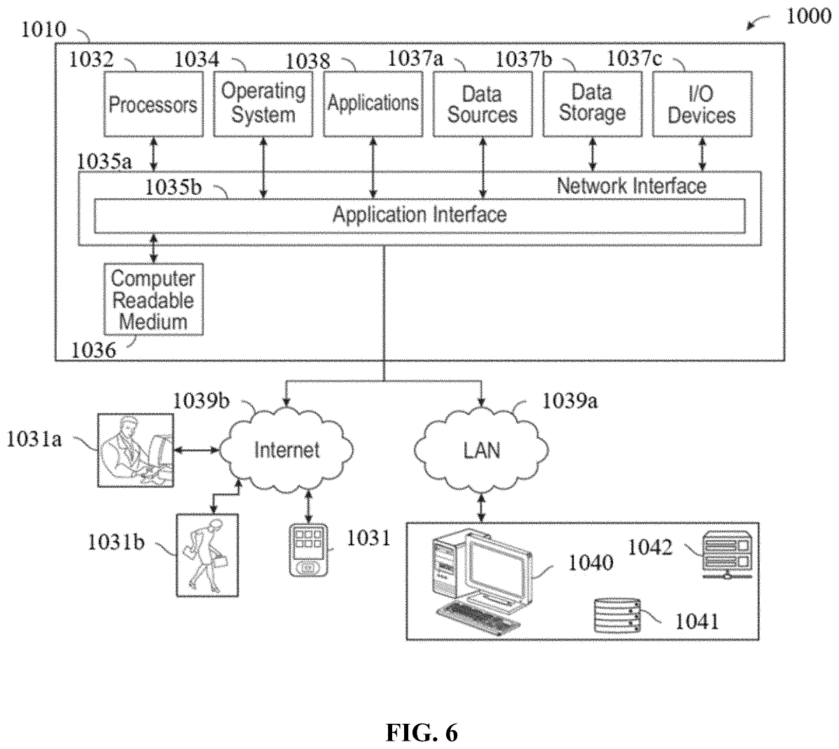

FIG. 6 illustrates a computer system 1010 enabling or comprising the systems and methods in accordance with some embodiments of the system. In some embodiments, the computer system 1010 can operate and/or process computer-executable code of one or more software modules of the aforementioned system and method. Further, in some embodiments, the computer system 1010 can operate and/or display information within one or more graphical user interfaces (e.g., HMIs) integrated with or coupled to the system.

In some embodiments, the computer system 1010 can comprise at least one processor 1032. In some embodiments, the at least one processor 1032 can reside in, or coupled to, one or more conventional server platforms (not shown). In some embodiments, the computer system 1010 can include a network interface 1035a and an application interface 1035b coupled to the least one processor 1032 capable of processing at least one operating system 1034. Further, in some embodiments, the interfaces 1035a, 1035b coupled to at least one processor 1032 can be configured to process one or more of the software modules (e.g., such as enterprise applications 1038). In some embodiments, the software application modules 1038 can include server-based software, and can operate to host at least one user account and/or at least one client account, and operate to transfer data between one or more of these accounts using the at least one processor 1032.

With the above embodiments in mind, it is understood that the system can employ various computer-implemented operations involving data stored in computer systems. Moreover, the above-described databases and models described throughout this disclosure can store analytical models and other data on computer-readable storage media within the computer system 1010 and on computer-readable storage media coupled to the computer system 1010 according to various embodiments. In addition, in some embodiments, the above-described applications of the system can be stored on computer-readable storage media within the computer system 1010 and on computer-readable storage media coupled to the computer system 1010. In some embodiments, these operations are those requiring physical manipulation of physical quantities. Usually, though not necessarily, in some embodiments these quantities take the form of one or more of electrical, electromagnetic, magnetic, optical, or magneto-optical signals capable of being stored, transferred, combined, compared and otherwise manipulated. In some embodiments, the computer system 1010 can comprise at least one computer readable medium 1036 coupled to at least one of at least one data source 1037a, at least one data storage 1037b, and/or at least one input/output 1037c. In some embodiments, the computer system 1010 can be embodied as computer readable code on a computer readable medium 1036. In some embodiments, the computer readable medium 1036 can be any data storage that can store data, which can thereafter be read by a computer (such as computer 1040). In some embodiments, the computer readable medium 1036 can be any physical or material medium that can be used to tangibly store the desired information or data or instructions and which can be accessed by a computer 1040 or processor 1032. In some embodiments, the computer readable medium 1036 can include hard drives, network attached storage (NAS), read-only memory, random-access memory, FLASH based memory, CD-ROMs, CD-Rs, CD-RWs, DVDs, magnetic tapes, other optical and non-optical data storage. In some embodiments, various other forms of computer-readable media 1036 can transmit or carry instructions to a remote computer 1040 and/or at least one user 1031, including a router, private or public network, or other transmission or channel, both wired and wireless. In some embodiments, the software application modules 1038 can be configured to send and receive data from a database (e.g., from a computer readable medium 1036 including data sources 1037a and data storage 1037b that can comprise a database), and data can be received by the software application modules 1038 from at least one other source. In some embodiments, at least one of the software application modules 1038 can be configured within the computer system 1010 to output data to at least one user 1031 via at least one graphical user interface rendered on at least one digital display.

In some embodiments, the computer readable medium 1036 can be distributed over a conventional computer network via the network interface 1035a where the system embodied by the computer readable code can be stored and executed in a distributed fashion. For example, in some embodiments, one or more components of the computer system 1010 can be coupled to send and/or receive data through a local area network (“LAN”) 1039a and/or an internet coupled network 1039b (e.g., such as a wireless internet). In some embodiments, the networks 1039a, 1039b can include wide area networks (“WAN”), direct connections (e.g., through a universal serial bus port), or other forms of computer-readable media 1036, or any combination thereof.

In some embodiments, components of the networks 1039a, 1039b can include any number of personal computers 1040 which include for example desktop computers, and/or laptop computers, or any fixed, generally non-mobile internet appliances coupled through the LAN 1039a. For example, some embodiments include one or more of personal computers 1040, databases 1041, and/or servers 1042 coupled through the LAN 1039a that can be configured for any type of user including an administrator. Some embodiments can include one or more personal computers 1040 coupled through network 1039b. In some embodiments, one or more components of the computer system 1010 can be coupled to send or receive data through an internet network (e.g., such as network 1039b). For example, some embodiments include at least one user 1031a, 1031b, is coupled wirelessly and accessing one or more software modules of the system including at least one enterprise application 1038 via an input and output (“I/O”) 1037c. In some embodiments, the computer system 1010 can enable at least one user 1031a, 1031b, to be coupled to access enterprise applications 1038 via an I/O 1037c through LAN 1039a. In some embodiments, the user 1031 can comprise a user 1031a coupled to the computer system 1010 using a desktop computer, and/or laptop computers, or any fixed, generally non-mobile internet appliances coupled through the internet 1039b. In some embodiments, the user can comprise a mobile user 1031b coupled to the computer system 1010. In some embodiments, the user 1031b can connect using any mobile computing 1031c to wireless coupled to the computer system 1010, including, but not limited to, one or more personal digital assistants, at least one cellular phone, at least one mobile phone, at least one smart phone, at least one pager, at least one digital tablets, and/or at least one fixed or mobile internet appliances.

The subject matter described herein are directed to technological improvements to the field of simulation process modeling by enabling models to quickly and efficiently be generated based on historical operational data. The disclosure describes the specifics of how a machine including one or more computers comprising one or more processors and one or more non-transitory computer readable media implement the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g. a cloud of computing resources.

The embodiments of the invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

We claim:

1. A system for the execution of optimum setpoints comprising:
one or more computers comprising one or more processors and one or more non-transitory computer readable media, the one or more non-transitory computer readable media comprising program instructions stored thereon that when executed cause the one or more computers to:
generate, by the one or more processors, a graphical user interface (GUI) configured to enable a user to input one or more controllable variables that correspond to one or more equipment setpoints of at least one component in an industrial process;
receive, by the one or more processors, setpoint historical data including the one or more equipment setpoints during an operational timeframe;
receive, by the one or more processors, key performance indicator (KPI) historical data comprising one or more key performance indicators that each include a measure of the at least one component during the operational timeframe;
determine, by the one or more processors, one or more setpoint timeframes where the key performance indicators are above a predetermine value;
return, by the one or more processors, one or more setpoint values that include the one or more equipment setpoints during the one or more setpoint timeframes.

2. The system of claim 1,
the one or more non-transitory computer readable media further comprising program instructions stored thereon that when executed cause the one or more computers to:
generate, by the one or more processors, a pseudo process model;
include, by the one or more processors, one or more KPI achieved timeframes that include where one or more key performance indicators are above a predetermine value;
exclude, by the one or more processors, one or more non-KPI achieved timeframes where the one or more key performance indicators are below the predetermine value from the pseudo process model;
execute, by the one or more processors, a setpoint calculation configured to determine one or more optimum setpoint values for the one or more components that correspond to the one or more equipment setpoints during the one or more KPI achieved timeframes; and
display, by the one or more processors, the one or more optimum setpoint values on the GUI.

3. The system of claim 2,
the one or more non-transitory computer readable media further comprising program instructions stored thereon that when executed cause the one or more computers to:
execute, by the one or more processors, a command to change the one or more equipment setpoints of the at least one component in the industrial process to the one or more optimum setpoint values.

4. The system of claim 2,
the one or more non-transitory computer readable media further comprising program instructions stored thereon that when executed cause the one or more computers to:
generate, by the one or more processors, a graphical user interface (GUI) comprising an optimum setpoint limit input, the optimum setpoint limit input configured to enable a user to implement a setpoint value limit and a setpoint range limit for the one or more setpoint values.

5. The system of claim 4,
the one or more non-transitory computer readable media comprising program instructions stored thereon that when executed cause the one or more computers to:
execute, by the one or more processors, a down-sample command configured to reduce a number of time series data points in the setpoint historical data before generation of the pseudo model.

6. The system of claim 2,
wherein the one or more setpoint values includes a mean value and/or standard deviation value.

7. The system of claim 6,
wherein the system is configured to set an optimum setpoint range to the standard deviation value.

8. The system of claim 7,
wherein the optimum setpoint range is less than the setpoint range limit.

9. A system for the execution of optimum setpoints comprising:
a historian server,
a statistical aggregation unit, and
a dynamic aggregation unit, and
one or more computers comprising one or more processors and one or more non-transitory computer readable media, the one or more non-transitory computer readable media comprising program instructions stored thereon that when executed cause the one or more computers to:
receive, by the statistical aggregation module, historical operational data from one or more sensors monitoring a process, the historical operational data including one or more tags and one or more setpoints associated with the one or more tags;
execute, by the statistical aggregation unit, a down-sample of the historical operational data to create statistical data, the statistical data including one or more of a mean and a standard deviation for each of the one or more setpoints;
execute, by the one or more processors, a setpoint calculation configured to determine one or more optimum setpoint values for the one or more components that correspond to the one or more setpoints during one or more key performance indictor (KPI) achieved timeframes; and
display, by the one or more processors, the one or more optimum setpoint values on the GUI.

10. The system of claim 9,
wherein the one or more non-transitory computer readable media further comprise program instructions stored thereon that when executed cause the one or more computers to:
correlate, by the dynamic aggregation unit, each setpoint to the one or more key performance indicators (KPIs);
determine, by the dynamic aggregation unit, one or more setpoint timeframes where the KPIs are above a predetermine value; and
return, by the dynamic aggregation unit, one or more setpoint values that include the one or more setpoints during the one or more setpoint timeframes.

11. The system of claim 10,
wherein the one or more non-transitory computer readable media further comprise program instructions stored thereon that when executed cause the one or more computers to:
generate, by the one or more processors, a survival model that includes an optimum value that includes an optimum highest value for each of the one or more setpoints that correlate to the highest KPI values and/or an optimum longest value for each of the one or more setpoints that correlate to a longest duration of meeting or exceeding a predetermined KPI value.

12. The system of claim 11,
further comprising a data validation unit, and
a model generation unit; and
wherein the one or more non-transitory computer readable media further comprise program instructions stored thereon that when executed cause the one or more computers to:
send, by the statistical aggregation unit, the survival model to the data validation unit; and
execute, by the data validation unit, a data validation of the survival model using curve fitting data modeling techniques.

13. The system of claim 12,
further comprising a setpoint optimizer unit;
wherein the one or more non-transitory computer readable media further comprise program instructions stored thereon that when executed cause the one or more computers to:
adjust, by the setpoint optimizer unit, one or more process setpoints based on the results of the survival model;

14. The system of claim 12,
wherein the system does not include a first-principals equation model to determine the optimum value.

15. The system of claim 12,
wherein the system does not include an iteration of a first-principals equation to determine the optimum value.

16. The system of claim 12,
wherein the system does not include an iteration model to determine the optimum value.

17. The system of claim 12,
wherein the survival model includes a mean and a standard deviation for each of the one or more setpoints.

18. The system of claim 12,
wherein the one or more non-transitory computer readable media further comprise program instructions stored thereon that when executed cause the one or more computers to:
generate, by the one or more processors, a graphical user interface, the graphical user interface including one or more bar charts, the one or more bar charts depicting a duration for each of the one or more optimum values.
